(19) United States
(12) Patent Application Publication
(10) Pub. No.: US 2025/0214747 A1
(43) Pub. Date: Jul. 3, 2025

(54) PALLET AND PALLET SYSTEM

(71) Applicant: Packaging Concepts & Design, LLC, Troy, MI (US)

(72) Inventors: Mike VANDERWOUD, Menlo Park, CA (US); Terry L. FIELDER, Westland, MI (US)

(21) Appl. No.: 19/082,767

(22) Filed: Mar. 18, 2025

Related U.S. Application Data
(63) Continuation-in-part of application No. 18/480,183, filed on Oct. 3, 2023.
(60) Provisional application No. 63/414,300, filed on Oct. 7, 2022.
(60) Provisional application No. 63/575,348, filed on Apr. 5, 2024.

(51) Int. Cl. B65D 19/38; B65D 19/00; F16F 7/00

(52) U.S. Cl. CPC B65D 19/385; B65D 19/0012; F16F 7/00; B65D 2519/00955; F16F 2238/026

(57) ABSTRACT

A pallet includes an upper frame, a lower frame opposite the upper frame, a first suspension system disposed between the upper frame and the lower frame and configured to provide dampening between the upper frame and the lower frame, and a first spring shock rod assembly located alongside the first suspension system.

### TECHNICAL FIELD

This disclosure relates generally to a pallet system, and more particularly to pallet system comprising an adjustable suspension system.

### BACKGROUND

This section provides background information related to the present disclosure and is not necessarily prior art. Pallets are used to transport and store objects and assemblies. For example, known wooden pallets can be loaded with products and transported between various locations. While known pallets have proven acceptable for their intended purposes, there exists a continuous need for improvement in the pertinent art.

### SUMMARY

This section provides a general summary of the disclosure, and is not a comprehensive disclosure of its full scope or all of its features.

In one aspect, a pallet includes an upper frame, a lower frame opposite the upper frame, a first suspension system disposed between the upper frame and the lower frame and configured to provide dampening between the upper frame and the lower frame, and a first spring shock rod assembly located alongside the first suspension system.

In implementations, multiple suspensions systems and corresponding spring shock rod assemblies are provided.

In implementations, a first impact damper assembly is located proximate the first suspension system.

In another aspect, a pallet may include an upper frame, a lower frame, and a first suspension system. The lower frame may be opposite the upper frame. The upper frame and the lower frame may define a distance therebetween. The first suspension system may be disposed between the upper frame and the lower frame and configured to provide damping between the upper frame and lower frame and/or to selectively modify the distance between the upper frame and the lower frame.

Implementations of the disclosure may include one or more of the following optional features. In some implementations, the first suspension system includes a bladder operable to store a volume of fluid. The bladder may include a valve operable to receive the volume of fluid.

In some implementations, the pallet includes a second suspension system disposed between the upper frame and the lower frame and configured to selectively modify the distance between the upper frame and the lower frame. The first suspension system may be located at a first corner of the upper frame, and the second suspension system may be located at a second corner, opposite the first corner, of the upper frame.

In some implementations, the pallet includes a first buckle pivotally coupled to the upper frame or the lower frame, and a second buckle pivotally coupled to the upper plate or the lower plate.

In some implementations, the pallet includes a strap coupled to the first buckle and the second buckle.

In some implementations, the pallet includes a strap having a first end coupled to one of the upper frame or the lower frame, and a second end opposite the first end and coupled to one of the upper frame or the lower frame. In some implementations, the pallet includes a shroud disposed over the strap.

The details of one or more implementations of the disclosure are set forth in the accompanying drawings and the description below. Other aspects, features, and advantages will be apparent from the description and drawings, and from the claims.

### DESCRIPTION OF DRAWINGS

The drawings described herein are for illustrative purposes only of selected configurations and not all possible implementations, and are not intended to limit the scope of the present disclosure.

FIG. 1A is a perspective view of a pallet system in a first configuration according to the principles of the present disclosure.

FIG. 1B is a perspective view of the pallet system of FIG. 1A in a second configuration according to the principles of the present disclosure.

FIG. 1C is a perspective view of the pallet system of FIG. 1A in a third configuration according to the principles of the present disclosure.

FIG. 2 is a top perspective view of a pallet according to the principles of the present disclosure.

FIG. 3 is a bottom perspective view of the pallet of FIG. 2.

FIG. 4 is a top view of the pallet of FIG. 2.

FIG. 5 is a bottom view of the pallet of FIG. 2.

FIG. 6 is a side view of the pallet of FIG. 2.

FIG. 7 is another side view of the pallet of FIG. 2.

FIG. 8 is a cross-sectional view of the pallet of FIG. 2, taken through the line 8-8 of FIG. 4.

FIG. 9 is a cross-sectional view of the pallet of FIG. 2, taken through the line 9-9 of FIG. 4.

FIG. 10 is a top perspective view of another pallet according to the principles of the present disclosure.

FIG. 11 is an exploded view of the pallet of FIG. 10.

FIG. 12 is a bottom perspective view of the pallet of FIG. 10.

FIG. 13 is a top view of the pallet of FIG. 10.

FIG. 14 is a side view of the pallet of FIG. 10.

FIG. 15 is another side view of the pallet of FIG. 10.

FIG. 16 is a cross-sectional view of the pallet of FIG. 10, taken through the line 16-16 of FIG. 14.

FIG. 17 is a cross-sectional view of the pallet of FIG. 2, taken through the line 17-17 of FIG. 14.

FIGS. 18-20 show another embodiment of a pallet.

FIGS. 21-23 show another embodiment of a pallet.

FIGS. 24-29 show another embodiment of a pallet.

FIGS. 30-33 show the pallet connected to a ramp.

FIGS. 34-38 show the ramp in isolation.

FIG. 39 shows an alternative spring shock rod assembly.

Like reference symbols in the various drawings indicate like elements.

### DETAILED DESCRIPTION

People and entities design, develop, test and produce pallets for storing and transporting of product and assemblies such as server racks. Often, such pallets are formed from a configuration of wood and/or foam that is unique to the particular design, configuration, and/or weight of the rack to allow for secure shipment between various locations (e.g., rack integrators, data center sites, etc.). The utilization of a unique pallet configuration for a unique server rack configuration is often ineffective from a cost, efficiency, and/or sustainability perspective, since it is often necessary to return, scrap, or otherwise dispose of the wood, foam, ramps, and/or other components that form the pallet.

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

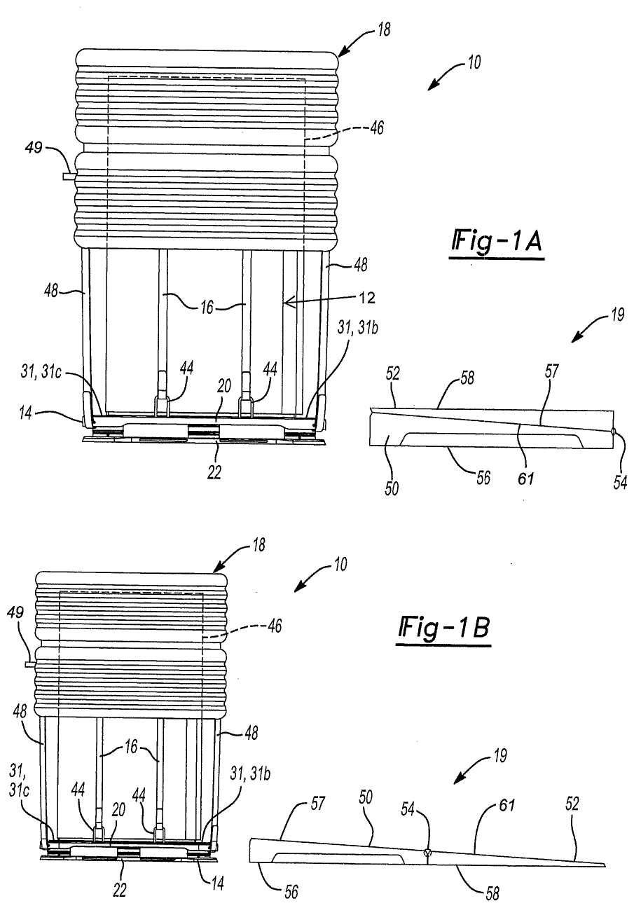

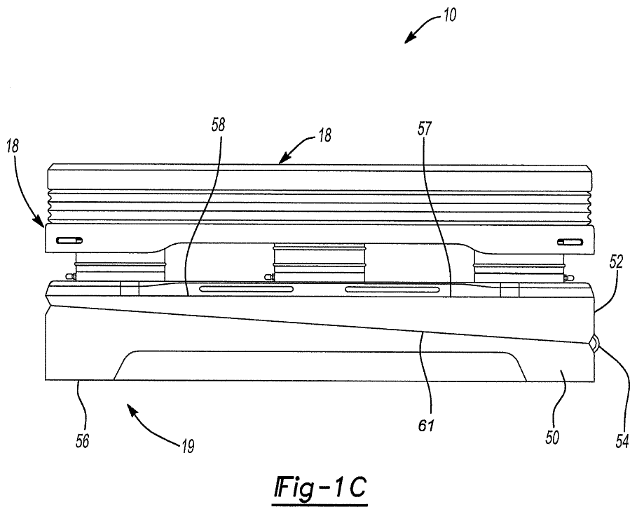

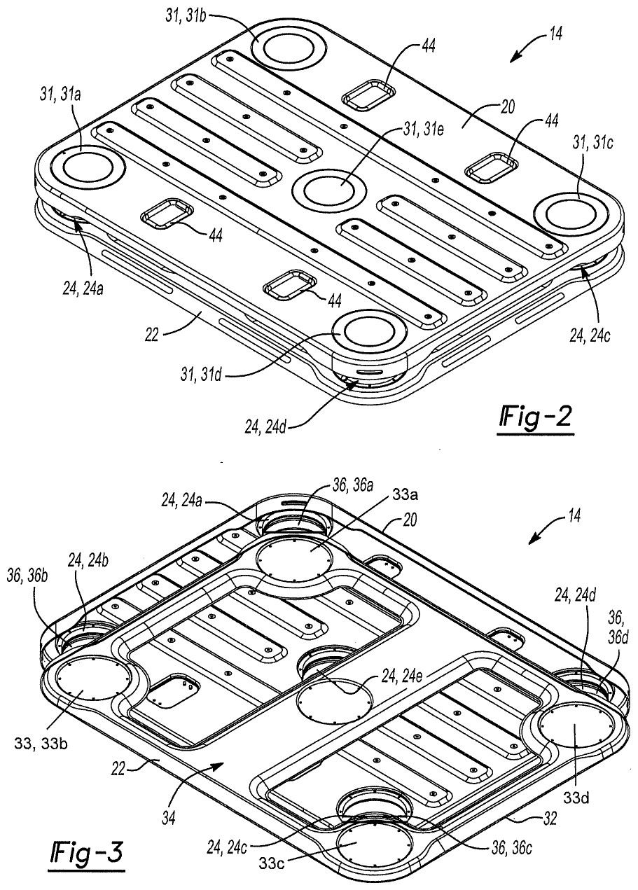

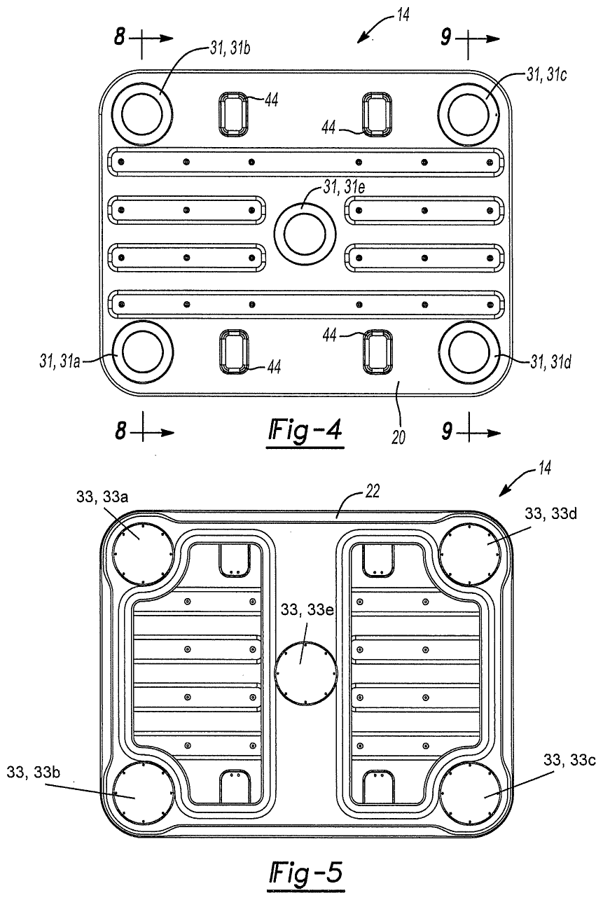

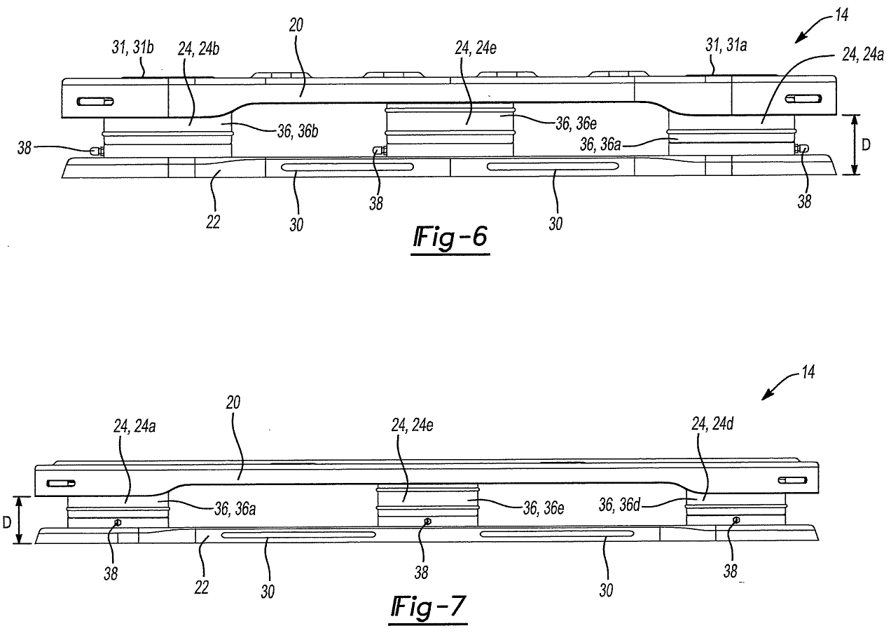

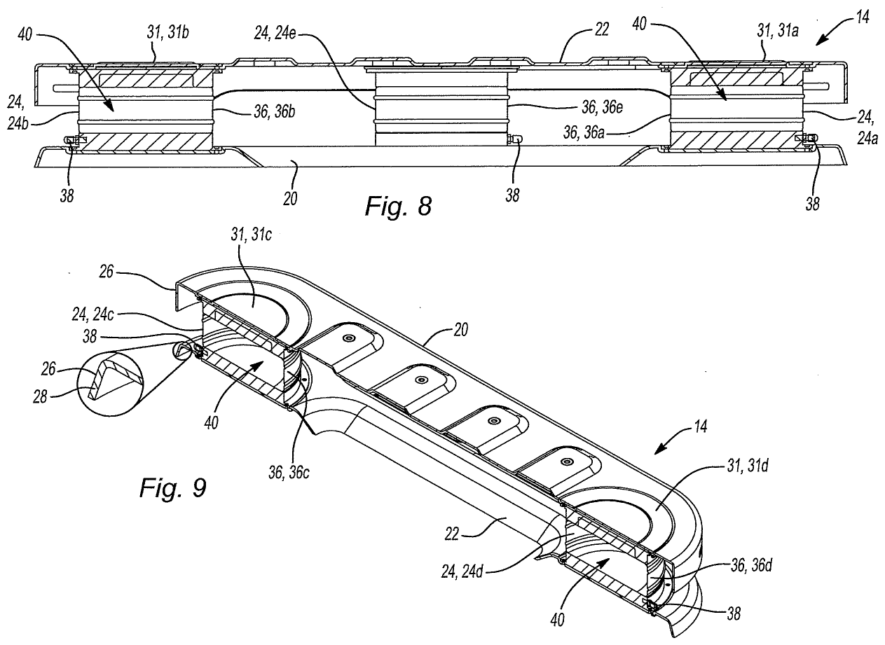

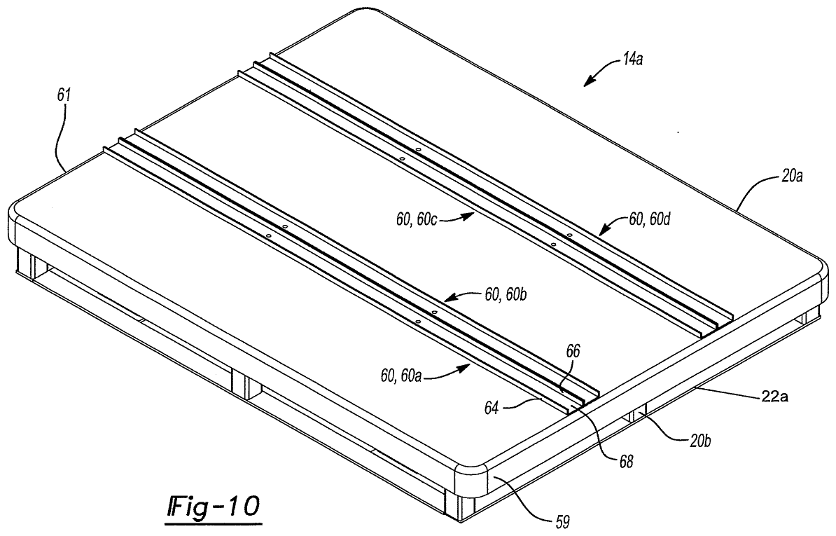

Referring to FIGS. 1A-9, a pallet system 10 may be utilized to store and/or transport a product or other assembly 12 (e.g., a computer server rack). In this regard, while the pallet system 10 is generally shown and described herein as storing and/or transporting a computer server rack, it will be appreciated that the pallet system 10 may store and/or transport other products and/or assemblies within the scope of the present disclosure.

The pallet system 10 may include a pallet 14, one or more straps 16, a cover assembly 18, and a ramp 19. As illustrated, the pallet 14 may include an upper frame 20, a lower frame 22, and one or more suspension systems 24. In some implementations, the upper frame 20 and/or the lower frame 22 is a thermoformed plate construct including an outer base structure 26 and an aluminum inner frame 28. In this regard, the upper frame 20 and the lower frame 22 may be referred to herein as the upper plate 20 and the lower plate 22, respectively.

In some implementations, the lower plate 22 defines one or more apertures 30 or other features to allow a fork-lift or hand truck to engage the pallet 14, as is known in the art. In particular, the apertures 30 may be defined through the outer base structure 26 and/or the aluminum inner frame 28 of the lower plate 22.

The upper plate 20 may further include one or more casters 31 to allow for ease of loading of the assembly 12 onto, and removal from, the upper plate 20. In some implementations, the upper plate 20 includes five casters 31a, 31b, 31c, 31d, 31e, each disposed at respective corners, and a central portion, of the upper plate 20.

The lower plate 22 may include one or more pads 33 to support, and allow for ease of stacking, the pallets 14. In some implementations, the upper plate 20 includes five pads 33a, 33b, 33c, 33d, 33e, each disposed at respective corners, and a central portion, of the lower plate 20, and substantially aligned with the casters 31a, 31b, 31c, 31d, 31e. The component designations 31a-31e may also simply be mount locations of the upper ends of each suspension system component (e.g., bladder damper) mad the component designations 33a-33e may also simply be mount locations of the lower ends of each system component. Casters and pads do not need to be included.

The lower plate 22 may include an outer and/or peripheral flange 32 defining and/or surrounding a chamber 34. The flange 32 and/or chamber 34 may be sized and shaped to receive the upper plate 20 such that a plurality of pallets 14 can be arranged in a stacked configuration, with the lower plate 22 (e.g., chamber 34) of a first pallet 14 receiving, and the flange 32 of the first pallet 14 surrounding, the upper plate 22 of a second pallet 14, and the lower plate 22 (e.g., chamber 34) of a third pallet 14 receiving, and the flange 32 of the third pallet 14 surrounding, the upper plate 22 of the first pallet 14. In this way, the pallets 14 (e.g., the upper and lower plates 20, 22) may be nestable with other pallets 14 to reduce space requirements for storage and shipment.

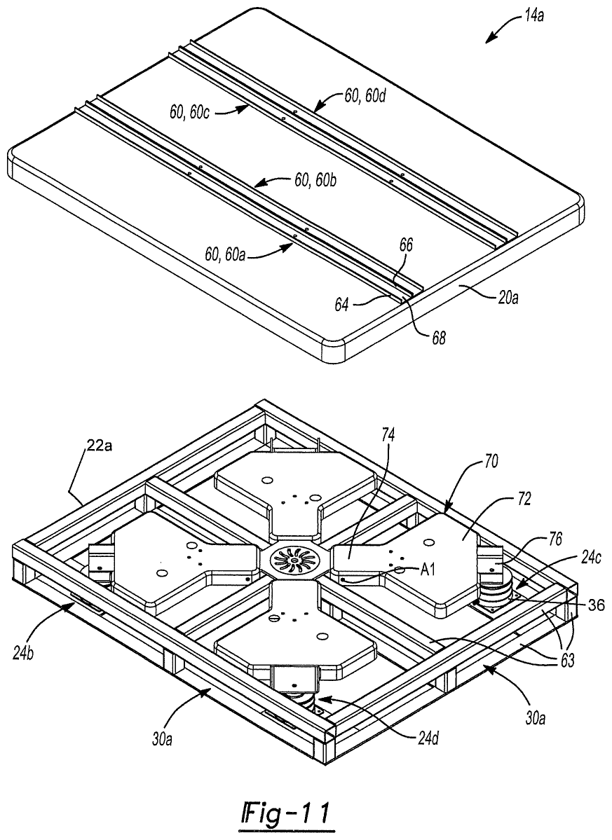

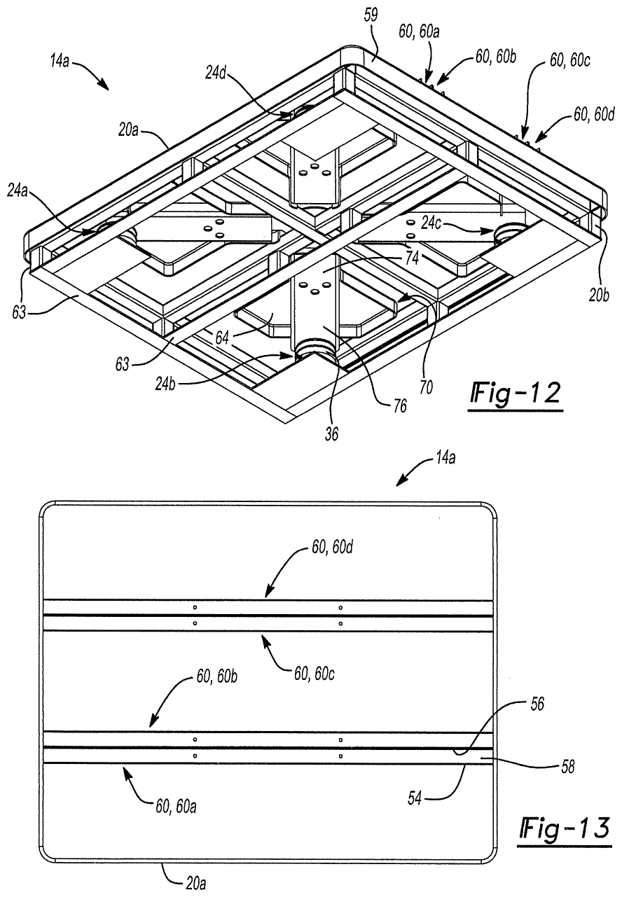

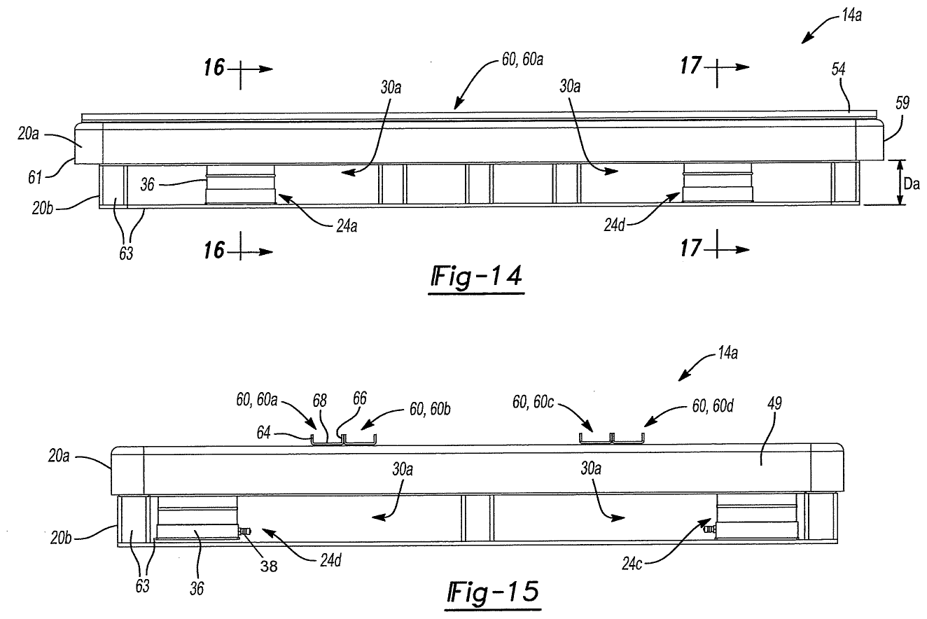

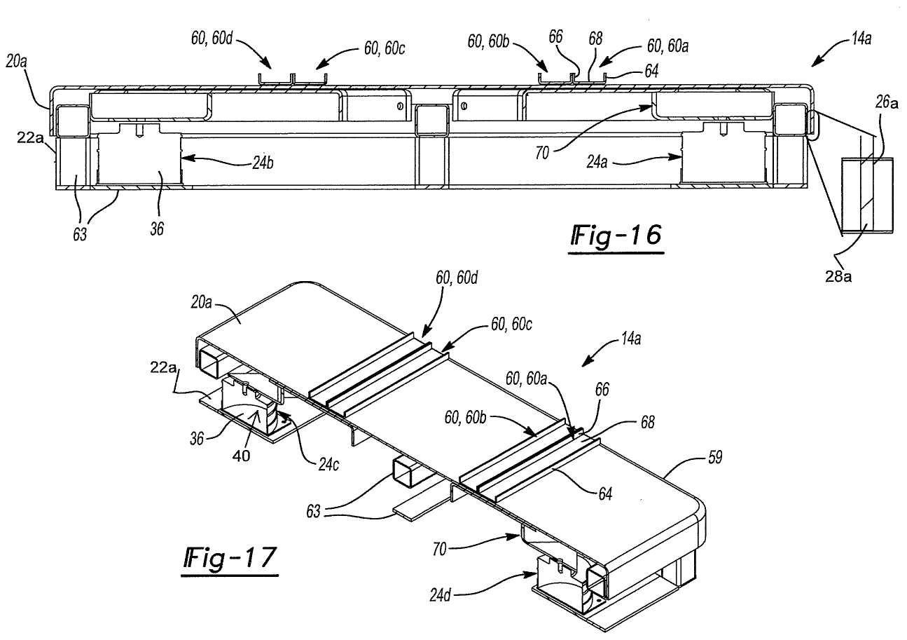

The suspension system(s) 24 may include a bladder 36 and a valve 38. The bladder 36 may extend between the upper and lower plates 20, 22. In some implementations, the bladder 36 defines a sealed volume 40 (FIGS. 8 and 9) with, and/or relative to, the upper and/or lower plates 20, 22. The valve 38 may be coupled to the bladder 36 and, selectively, in fluid communication with the volume 40. Accordingly, during use, a user may inject a fluid (e.g., air) through the valve 38 to inflate the volume 40, which in some cases may also increase a distance D (FIGS. 6 and 7) between the upper and lower plates 20, 22. Similarly, a user may remove a fluid (e.g., air) through the valve 38 to deflate the volume 40, which in some cases may decrease the distance D between the upper and lower plates 20, 22. In some implementations, the pallet 14 includes five suspension systems 24a, 24b, 24c, 24d, 24e, each disposed at respective corners, and a central portion, of the upper and lower plates 20, 22, and each include a respective bladder 36a, 36b, 36c, 36d, 36e and a valve 38, thus allowing a user to selectively control the damping characteristics (and in some cases the distance D) at the location of each suspension systems 24a, 24b, 24c, 24d, 24e, as may be desired to facilitate transport of a particular size and shape of a computer server rack on the pallet with limited transfer of shock forces upward through the pallet and to the server rack. In this regard, the suspension systems 24a, 24b, 24c, 24d, 24e may be substantially aligned with the casters 31a, 31b, 31c, 31d, 31e and/or pads 33a, 33b, 33c, 33d, 33e. While each suspension system 24a, 24b, 24c, 24d, 24e is illustrated and described herein as including a valve 38, it will be appreciated that the pallet 14 may include a single valve 38 in fluid communication with each of the volumes 40 (e.g., through a manifold) defined by the bladders 36a, 36b, 36c, 36d, 36e.

In some implementations, the suspension system(s) 24 is removably-coupled to the upper and/or lower plate 20, 22, such that a user can remove a suspension system 24 having a first set of characteristics (e.g., volume of chamber, thickness of bladder 36, distance D, etc.) and replace it with a suspension system having a second set of characteristics (e.g., volume of chamber, thickness of bladder 36, distance D, etc.) that is different than the first set of characteristics.

The strap(s) 16 may be removably-coupled to the pallet 14 (e.g., the upper plate 20) to secure the assembly 12 thereto. In this regard, in some implementations the upper plate 20 includes one or more buckles or other strap connects 44 coupled thereto for removably-coupling to the straps(s).

The cover assembly 18 may include a shroud (e.g., chamber 46), one or more straps 48, and a valve 50. The chamber 46 may be removably-secured to the pallet 14 (e.g., upper plate 20) via, e.g., disposal over the assembly 12 and/or one or more straps or other suitable fastening members. In particular, the chamber 46 may be formed from a pliable material (e.g., as an air sock) and removably disposed over the straps 48 in an assembled configuration of the pallet system 10 to protect the assembly 12. In this regard, the cover assembly 18 can prevent the pallet 14 from moving relative to the surrounding environment when the cover assembly 18 is secured relative to a transport vehicle during transport of the assembly 12. During operation of the pallet system 10, the valve 50 can be used to inflate and/or deflate a volume defined within the chamber 46 with a fluid (e.g., air). The shroud could also be implemented as a foam cap and ring.

The ramp 19 may include a first portion 50, a second portion 52, and one or more hinges 54 that pivotally couple the first portion 50 to the second portion 52. The first portion 50 may include a lower surface 56 and an opposite upper surface 57 defining first angle relative to the lower surface 56, such that a maximum height of the upper surface 57 is substantially equal to a height of the pallet 14. The second portion 52 may include a lower surface 58 and an opposite upper surface 59 defining a second angle relative to the lower surface 58. As will be explained in more detail below, the first angle may substantially (+/−five degrees) equal to the second angle such that, in a first configuration (e.g., FIG. 1B), the upper surface 57 is substantially parallel to, and extending from, the upper surface 59, while, in a second configuration (e.g., FIG. 1C), the upper surface 57 is substantially parallel to, and facing, the upper surface 59. In particular, in the first configuration, the first and second portions 50, 52 may collectively form a ramp construct where the upper surfaces 57, 59 face the same direction, while in the second configuration, the first and second portions 50, 52 may collectively form a cuboid construct where the upper surface 57 engages the upper surface 59.

In some implementations, the pallet 14 has an adjustable suspension (e.g., suspension system 24) that can selectively and dynamically dampen the speed at which the upper plate 20 moves toward the lower plate 22 upon application of a force (e.g., the weight of the assembly 12) on the upper plate 20 and/or the lower plate 22 in a direction toward the other of the upper plate 20 and/or lower plate 22. In some implementations, the pallet 14 can extend the life cycle of the pallet 14 through modular design, allowing a lower-cost thermo-formed pallet to be disposed of (e.g., recycled) after a number (e.g., two, three, four, five, etc.) of uses, while higher-cost components (e.g., sub-frame) can be re-used indefinitely. In some implementations, the pallet 14 and/or collapsible cover assembly 18 eliminates a heavy wood crate while providing improved protection and security of the product (e.g., server rack 12) while also reducing contamination of the product that could otherwise be caused by wood particulates from, e.g., a wooden pallet.

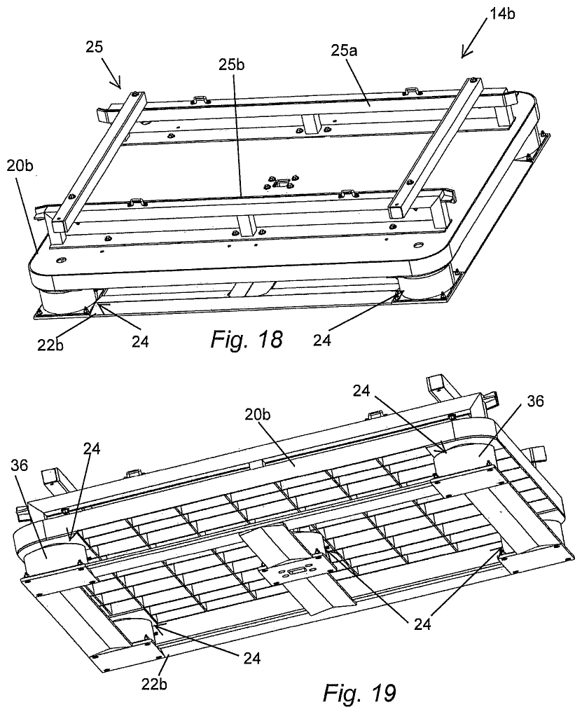

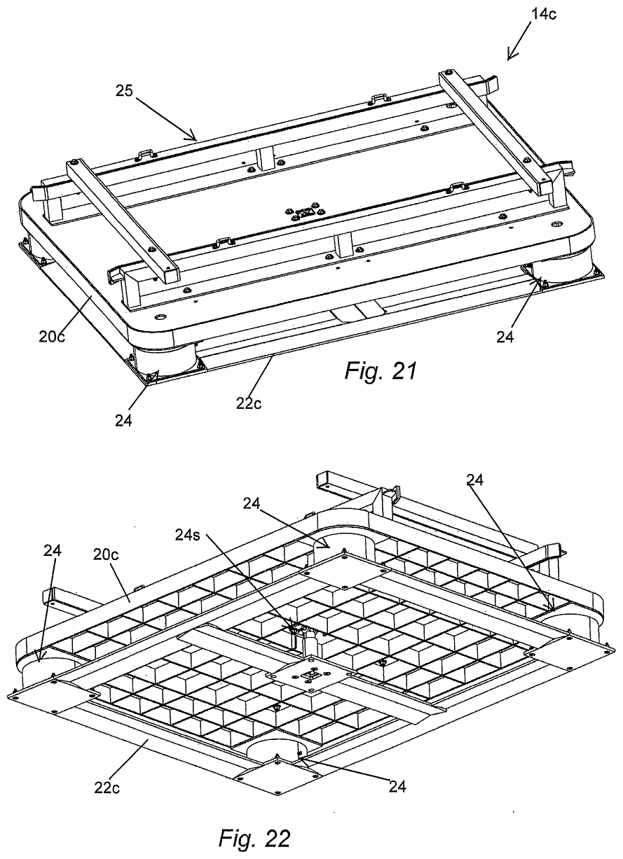

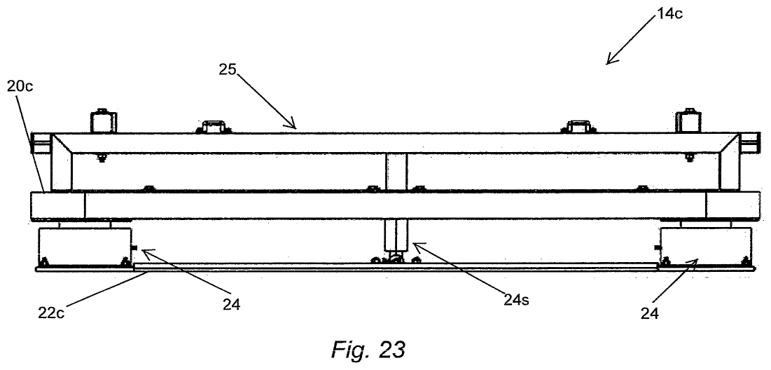

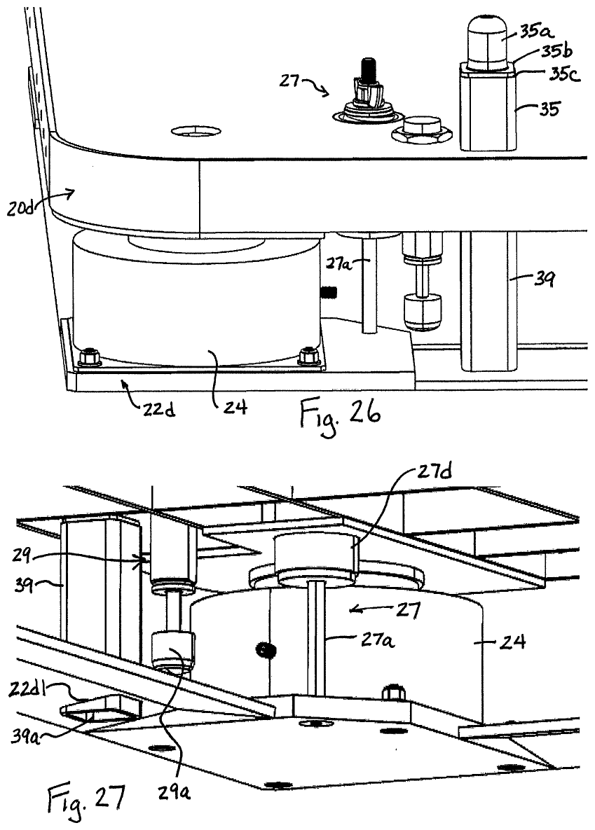

Referring now to FIGS. 10-17, a pallet 14a is provided and includes an upper frame 20a, a lower frame 22a, and the one or more suspension systems 24a. In view of the substantial similarity in structure and function of the components associated with the pallet 14a relative to the pallet 14, like reference numerals are used hereinafter and in the drawings to identify like components, while like reference numerals containing letter extensions (i.e., “a”) may be used to identify those components that have been modified. In this regard, the pallet 14a may be utilized with the pallet system 10 (e.g., assembly 12, straps 16, cover assembly 18) to store and/or transport the assembly 12 (e.g., a computer server rack).

In some implementations, the upper frame 20a and/or the lower frame 22a is a thermoformed plate construct including an outer base structure 26a and an aluminum inner frame 28a. In this regard, the upper frame 20a and the lower frame 22a may be referred to herein as the upper plate 20a and the lower plate 22a, respectively.

In some implementations, the lower plate 22a defines one or more apertures 30a or other features to allow a fork-lift or hand truck engagement, as is known in the art. In particular, the apertures 30a may be defined through the outer base structure 26a and/or the aluminum inner frame 28a of the lower plate 22a.

The upper plate 20a may further include one or more rails 60 to allow for ease of loading of the assembly 12 onto, and removal from, the upper plate 20a. In some implementations, the upper plate 20a includes four rails 60a, 60b, 60c, 60d, 60e, each extending across the upper plate 20a. In particular, each rail 60 may extend from a first lateral side 59 of the upper plate 20a to a second lateral side 61 of the upper plate 20a, opposite the first lateral side 59. In some implementations, each rail 60 defines a “U” shape including a first lateral flange 64, a second lateral flange 66, and a base 68 extending from the first lateral flange 64 to the second lateral flange 66. The first and/or second lateral flange 64, 66 may extend transversely from (e.g., orthogonal to) an upper surface of the upper plate 20a. In some implementations, each rail 60 is parallel to one or more (e.g., all) of the other rails 60. In some implementations, the second lateral flange 66 of the first rail 60a engages the first lateral flange of the second rail 60b, and the second lateral flange of the third rail 60c engages the first lateral flange of the fourth rail 60d. The lower plate 22a may include one or more support members 63 (e.g., beams, posts, trusses, etc.) extending from and between one another in various directions.

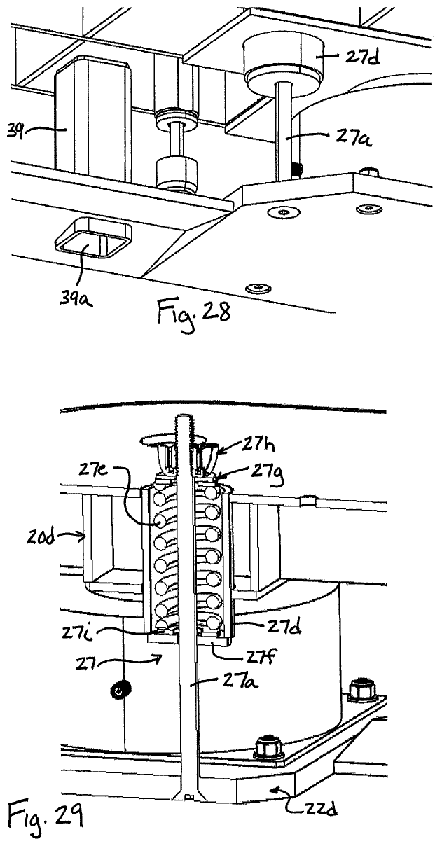

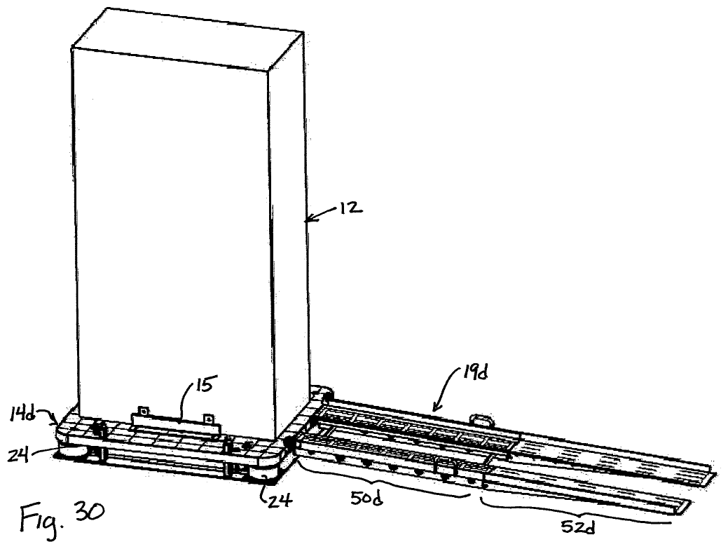

The suspension systems 24 may include the bladder 36, the valve 38, and a lifter 70. The bladder 36 may extend between the lower plates 22a and the lifter 70. In some implementations, the bladder 36 defines the sealed volume 40 (FIGS. 16 and 17) with, and/or relative to, the lower plate 22a and the lifter 70. The valve 38 may be coupled to the bladder 36 and, selectively, in fluid communication with the volume 40.

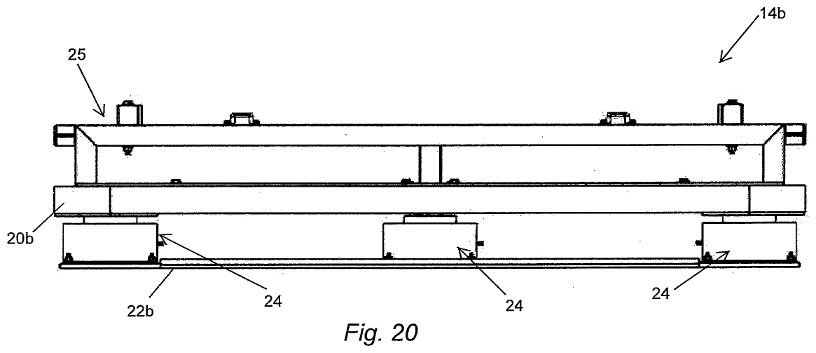

With reference to FIG. 11, the lifter 70 may include a housing 72 having a first end 74 coupled to the lower plate 22a, and a second end 76 engaging the bladder 36. In particular, the first end 74 may be pivotally coupled to one or more of the support members 63 with a pin or other suitable hinge member for rotation about an axis A1. The second end 76 may be coupled to the bladder 36 with a suitable fastener (e.g., bolt, screw, rivet, adhesive, etc.).

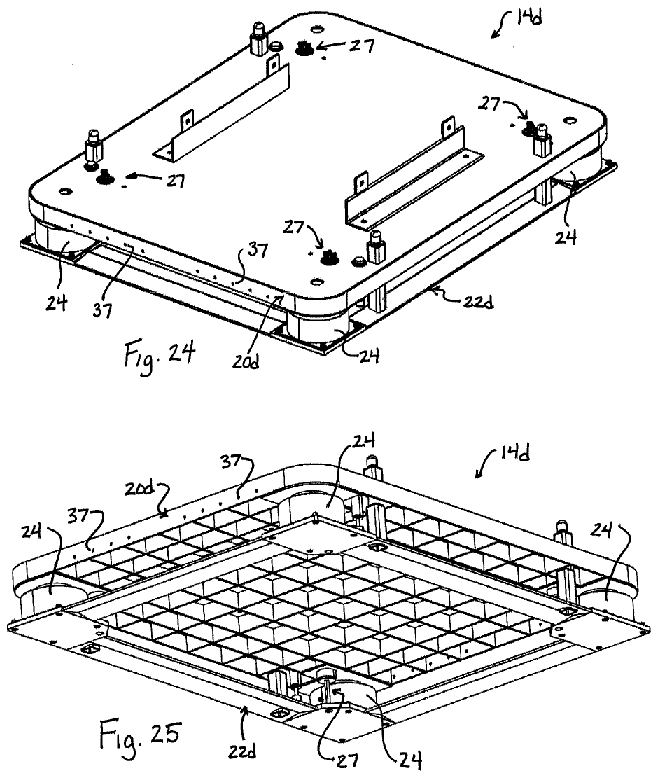

During use, a user may inject a fluid (e.g., air) through the valve 38 to inflate the volume 40, thereby causing the housing 72 to pivot in a first direction about the axis A1, thereby causing the second end 76 to engage, and increase a force on, the upper plate 20a, which in some cases may increase a distance Da (FIG. 14) between the upper and lower plates 20, 22. Similarly, a user may remove a fluid (e.g., air) through the valve 38 to deflate the volume 40, thereby causing the housing 72 to pivot in a second direction about the axis A1, thereby causing the second end 76 to engage, and decrease a force on, the upper plate 20a, in some cases decreasing a distance Da (FIG. 14) between the upper and lower plates 20a, 22a. In some implementations, the pallet 14a includes four suspension systems 24a, 24b, 24c, 24d, each disposed at respective corners, and a central portion, of the upper and lower plates 20a, 22a, and each including a respective bladder 36 and a valve 38, thus allowing a user to selectively control the distance Da at the location of each suspension systems 24a, 24b, 24c, 24d. While each suspension system 24a, 24b, 24c, 24d is illustrated and described herein as including a valve 38, it will be appreciated that the pallet 14a may include a single valve 38 in fluid communication with each of the volumes 40 defined by the bladders 36a, 36b, 36c, 36d.

In some implementations, the pallet 14a includes four suspension systems 24aa, 24b, 24c, 24d, each disposed at respective corners, of the upper and lower plates 20a, 22a,

In some implementations, the suspension system(s) 24 is removably-coupled to the upper and/or lower plate 20a, 22a, such that a user can remove a suspension system 24a having a first set of characteristics (e.g., volume of chamber, thickness of bladder 36, distance Da, etc.) and replace it with a suspension system having a second set of characteristics (e.g., volume of chamber, thickness of bladder 36, distance Da, etc.) that is different than the first set of characteristics.

In some implementations, the pallet 14a has an adjustable suspension (e.g., suspension system 24a) that can selectively dampen the speed at which the upper plate 20a moves toward the lower plate 22a upon application of a force on the upper plate 20a and/or the lower plate 22a in a direction toward the other of the upper plate 20a and/or lower plate 22a. In some implementations, the pallet 14a can extend the life cycle of the pallet 14a through modular design, allowing a lower-cost thermo-formed pallet to be disposed of (e.g., recycled) after a number (e.g., two, three, four, five, etc.) of uses, while higher-cost components (e.g., sub-frame) can be re-used indefinitely. In some implementations, the pallet 14a and/or collapsible cover assembly 18 eliminates a heavy wood crate while providing improved protection and security of the product (e.g., server rack 12) while also reducing contamination of the product that could otherwise be caused by wood particulates from, e.g., a wooden pallet.

Use of the pallet system 10, including the pallets 14, 14a, will now be described with reference to FIGS. 1A-1C. As illustrated in FIG. 1C, in a first mode of operation, a user may receive a kit including the pallet 14, 14a, the cover assembly 18, and the ramp 19. The pallet 14, 14a may be disposed upon the ramp 19 such that the lower surface 58 is engaging the lower plate 22, 22a. The cover assembly 18 may be disposed upon the upper plate 20, 20a of the pallet 14, 14a. With reference to FIG. 1B, in a second mode of operation, a user may remove the ramp 19 from the pallet 14, 14a and rotate the first portion 50 relative to the second portion 52 such that the lower surfaces 56, 58 face a first direction, and the upper surfaces 57, 59 face a second direction opposite the first direction. In this regard, in the second mode of operation, the first and second portions 50, 52 may form a ramp as previously described. In the second mode of operation, the user may move the assembly 12 on and across the upper surfaces 57, 59 until the assembly 12 is disposed upon the upper plate 20, 20a. The user may further secure the assembly 12 to the pallet 14, 14a using the straps 16 in the second mode of operation. The user may also place the cover assembly 18 over the assembly 12 and inflate the chamber 46 through the valve 50. The user may further inflate the bladder(s) 36 to a predetermined pressure. For example, the user may further inflate the bladder(s) 36 to a pressure based on the weight of the assembly 12, such that the distance D, Da remains constant regardless of the weight of the assembly 12. With reference to FIG. 1A, in a third mode of operation, the user may rotate the first portion 50 relative to the second portion 52 such that the upper surface 57 faces and/or engages the upper surface 59, and the first and second portions 50, 52 form a cuboid construct, as previously described.

In use, the pallet system 10, including the pallet 14, 14a can provide a customer with a low- to no-touch packaging solution that reduces the amount of effort and/or time required to deploy a new design for a server rack (e.g., server rack 12), while also allowing for (i) faster, cost-effective, and more reliable maintenance and ramping-up of server storage capacity in a data center, and (ii) a reduction in internal resources required to support packaging (e.g., pallet) design, qualification and management. In this regard, in some implementations, the pallet 14, 14a is capable of supporting products (e.g., server rack 12) having weights ranging from 1400 pounds (+/−20%) to 4400 pounds (+/−20%). In some implementations, the pallet 14, 14a is capable of accommodating products (e.g., server rack 12) having various sizes and/or footprints (e.g., configurations of the base of the server rack).

To provide for interaction with a user, one or more aspects of the disclosure (e.g., inflation techniques for the bladder 36 and/or the chamber 46) can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

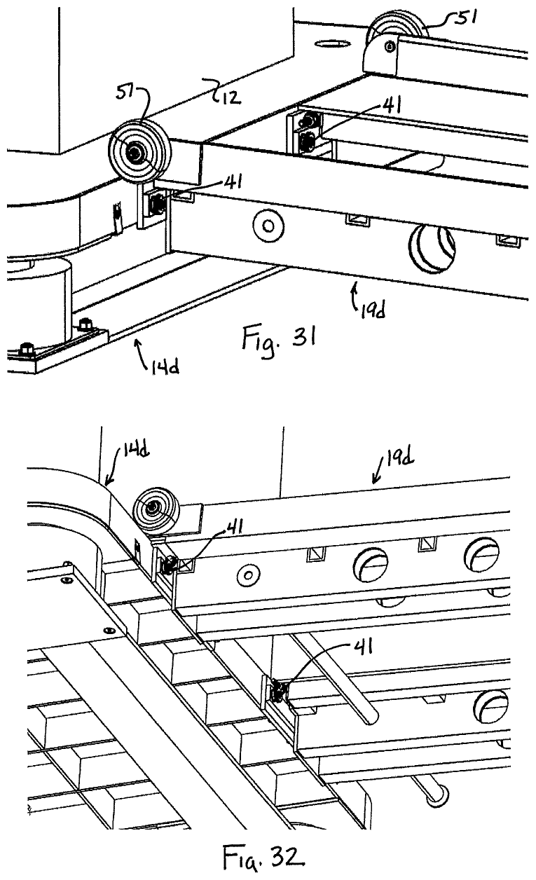

Referring to FIGS. 18-20, another pallet 14b is shown, which pallet 14b may also be used in the pallet system shown in FIGS. 1A-1C. The pallet 14b includes an upper frame 20b, a lower frame 22b and suspension systems 24 (five in total here) connected therebetween, each having a corresponding inflatable bladder 36. The upper frame 20b includes a top mounted set of raised bracket frame 25 that are configured to trap a server rack therein (e.g., one of the tubulars forming the bracket frame can be removed to slide/roll in the server rack, and then be fixed to snugly capture the lower end of the server rack). The bracket frame 25 includes slide rails 25a, 25b that taper outwardly at the ends to help guide the server rack into position as it is being loaded onto the pallet 14. The brackets also includes strap connects for strapping to secure the server rack. The upper and lower frames may both be of fabricated steel configuration, with upper frame 20b have a main plate structure and lower strut structure, and with lower frame 22b having an open frame configuration.

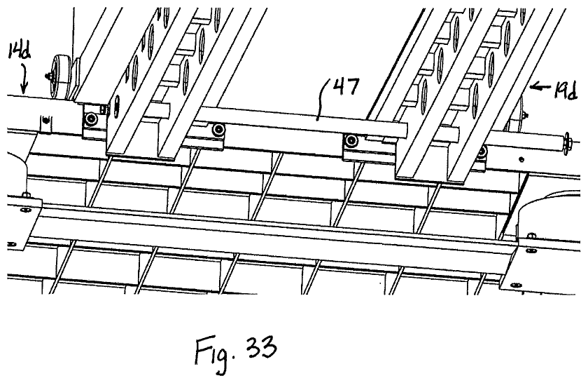

FIGS. 21-23 show another pallet 14c, identical in configuration to pallet 14b, except that the center located suspension system 24 is, unlike the corner located suspension systems 24, is configured as a two way shock (e.g., a two way air shock) that provides bi-directional damping (i.e., damping of compression between the upper frame 20c and the lower frame 22c, and damping of separation between the upper frame 20c and the lower frame 22c).

In certain use scenarios, the fluid bladder suspension systems 24 can result in an undesired rebound effect. Specifically, a significant force acting to move the upper frame and lower frame together is absorbed by the suspension systems 24, but can create a large reaction force that pushes the upper and lower frames apart in a manner that could cause the pallet to bounce upward.

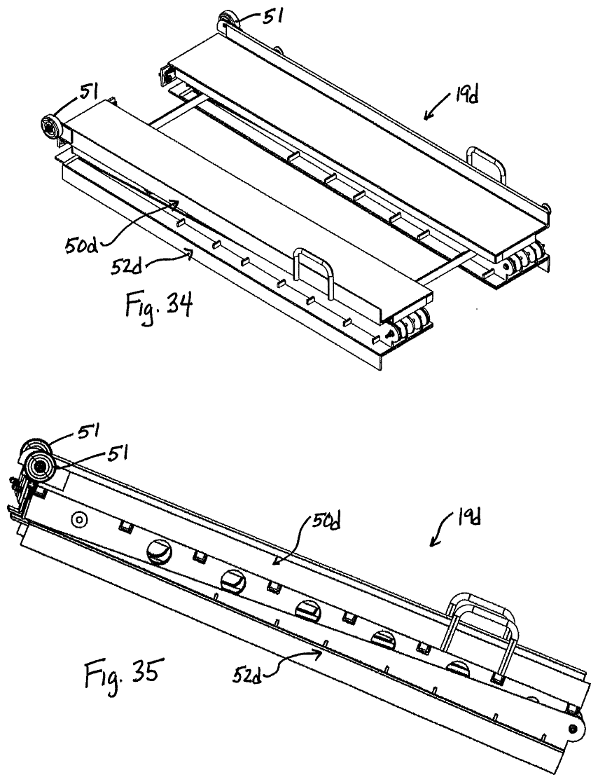

The pallet 14d of FIGS. 24-29 addresses this issue. Here, four corner located suspension systems 24 are provided between the upper frame 20d and the lower frame 22d. Each suspension system 24 may, by way of example, be in the form a pneumatic isolator as described in U.S. Pat. No. 3,836,134, which is incorporated herein by reference. A centrally located suspension system is not utilized this embodiment. A spring shock rod assembly 27 is provided proximate each suspension system 24. Each spring shock rod assembly includes a rod 27a that is fixed to the lower frame 22d (e.g., here the rod 27a is formed as a bolt extending upwardly through an opening in the lower frame and having a threaded upper end), a cylindrical housing 27d that is fixed to the upper frame 20d (e.g., by welding), and a spring 27e within the housing 27d. The bottom of the spring 27e presses against a bottom plate 27f that is fixed at the lower end of the housing 27d, or a rubber bumper 27i atop the bottom plate 27f. The top of the spring 27e seats against a washer set 27g, (e.g., washer and a rubber bumper) and the position of the washer set 27g along the rod 27a can be adjusted by rotation of a nut 27h (e.g., a wing nut) along the threaded upper portion of the rod. The location of housing 27d and lower end of the spring along the rod can vary by compression of the spring 27e, and the upper frame 20d and upper end of the housing 27d can move upward relative to the washer set 27g when the spring compresses. Thus, when a force acts to move the upper frame 20d and lower frame 22d apart (e.g., the above-described reactive force from the suspension system 24), the spring 27e compresses to counteract the reactive force, thereby limiting or preventing the bounce or rebound effect.

As noted above, in this embodiment, each suspension system 24 includes a corresponding spring shock rod assembly 27 positioned alongside the suspension system or otherwise proximate to the suspension system. Thus, each shock rod assembly can be primarily responsive to the reactive forces created by its nearby suspension system.

Additionally, four corner impact damper assemblies 29 (e.g., rod-type air dampers) are provided, each being proximate one of the suspension systems 24. When the upper frame 20d and lower frame 22d are moved toward each other (e.g., under a heavy load atop the pallet) the bumper 29a at the lower end of the damper assembly will contact the lower frame 22d, and any further movement of the frames toward each other will be dampened as a result. In some embodiments, the damper assemblies 29 may not be used.

Notably, the pallet 14d includes stacking features in the form of columns 35 and 39 (formed by rectangular tubulars, or some other tubular shape). Upper columns 35 have lower ends fixed to the upper frame 20d, and pins 35a project upward from the upper ends of the upper columns 35. Lower columns 39 have lower ends that extend down through openings 22d1 in the lower frame 22d. The upper ends of the upper columns 35 also have a seat feature 35b that is of reduced peripheral dimension that is sized to fit within the openings 39a at the bottoms of the lower columns 39 during pallet stacking, and provides a surrounding surface 35c on which the lower edges of the lower columns 39 of a stacked pallet rest. The pins 35a are provided to aid in preventing lateral sliding of the columns away from each other and to facilitate alignment during stacking. The lower columns 39 extend upward from the lower frame 22d by a set distance such that a spacing between the top of the lower column 39 and the bottom of the upper frame 20d is provided. Thus, the lower columns 39 act as receivers for the pins 35a of a lower pallet during stacking, and also operate as safety stops that limits potential downward movement of the upper frame 20d if the adjacent suspension system 24 fails.

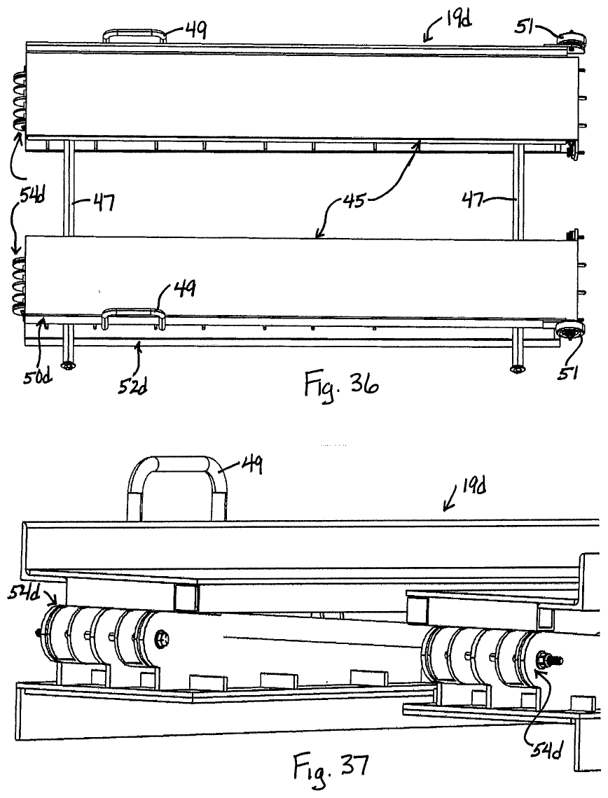

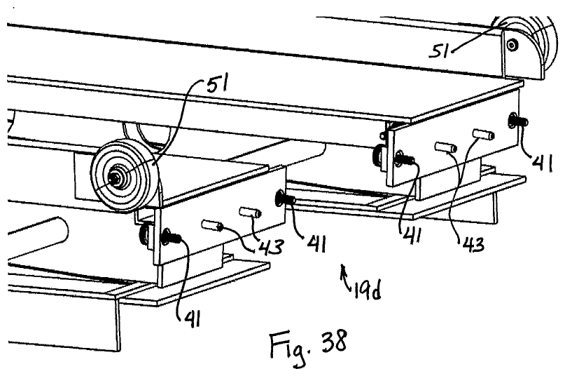

Here, one or more sides (here the two short sides) of the upper frame 20d are provided with a series of openings 37 thereon for the purpose of attachment of ramps that can be used for loading of the pallet. In this regard, reference is made to FIGS. 30-33 showing a pallet and ramp combination (or portions thereof), and FIGS. 34-38 showing the ramp in isolation in a folded or transport configuration. The pallet 14d is loaded with a server rack 12 between brackets 15 atop the upper frame of the pallet, and a ramp 19d is attached at one side of the pallet using a set of threaded fasteners 41 and/or pins 43 that engage into the side openings of the upper frame.

The ramp 19d includes a portion 50d, a portion 52d, and one or more hinges 54d that pivotally couple the two portions. In the folded or transport configuration, the portions 50d, 52d may collectively form a cuboid construct in side elevation. The ramp 19d includes laterally spaced apart rail sections 45 that are interconnected by rods 47 in a manner that allows the spacing between the rail sections 45 to be adjusted. Handles 49 are provided for handling, along with wheels 51 at one end (when in the folded configuration) to facilitate rolling movement of the ramp when in the folded configuration.

In embodiments, sensors may be provided in association with each of the suspension systems 24 to provide temperature indication and/or or pressure indication for each suspension system 24.

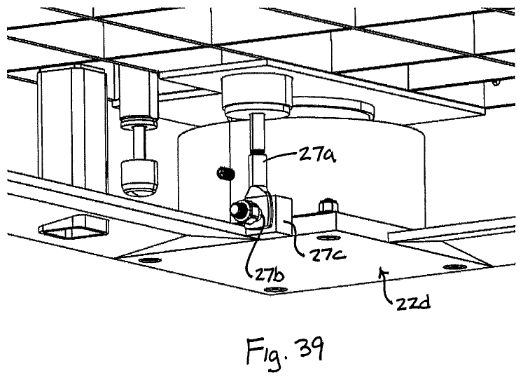

In an alternative embodiment, shown in FIG. 39, the rod 27a of each spring shock assembly may be pivotably connected to the lower frame 22d (e.g., via a fixed pivot pin 27b that extends through an opening in a mount part 27c at the lower end of the rod).

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

1. A pallet, comprising:
an upper frame;
a lower frame opposite the upper frame;
a first suspension system disposed between the upper frame and the lower frame and configured to provide dampening between the upper frame and the lower frame; and
a first spring shock rod assembly located alongside the first suspension system.

2. The pallet of claim 1, further comprising:
a second suspension system disposed between the upper frame and the lower frame and configured to provide dampening between the upper frame and the lower frame;
a second spring shock rod assembly located alongside the second suspension system;
a third suspension system disposed between the upper frame and the lower frame and configured to provide dampening between the upper frame and the lower frame;
a third spring shock rod assembly located alongside the third suspension system;
a fourth suspension system disposed between the upper frame and the lower frame and configured to provide dampening between the upper frame and the lower frame;
a fourth spring shock rod assembly located alongside the fourth suspension system;
wherein the first, second, third and fourth suspension systems are located at respective first, second, third and fourth corner regions of the pallet.

3. The pallet system of claim 2, further comprising:
a first impact damper assembly located in the first corner region;
a second impact damper assembly located in the second corner region;
a third impact damper assembly located in the third corner region; and
a fourth impact damper assembly located in the fourth corner region.

4. The pallet of claim 1, wherein the first spring shock rod assembly comprises a first spring that compresses during a movement of the upper frame away from the lower frame to provide a force, between the upper frame and the lower frame, and which opposes the movement.

5. The pallet of claim 4, wherein the first spring shock rod assembly comprises a first cylindrical housing that is fixed to the upper frame, and the first spring is located within the cylindrical housing, and a first rod of the first spring shock rod assembly passes through the cylindrical housing, and the first spring is disposed about a portion of the first rod.

6. The pallet of claim 5, wherein a bottom of the first spring seats against (i) a first bottom plate that is fixed at a lower end of the first cylindrical housing or (ii) a rubber bumper atop the first bottom plate.

7. The pallet of claim 6, wherein a top of the first spring seats against a washer or a rubber bumper, and a position of the washer or rubber bumper along the first rod is adjustable by rotation of a nut along a threaded upper portion of the first rod.

8. The pallet of claim 7, wherein the nut is disposed atop the upper frame, and a lower end of the first rod is fixedly connected to the lower frame.

9. The pallet of claim 7, wherein the nut is disposed atop the upper frame, and a lower end of the first rod is pivotable connected to the lower frame.

10. The pallet of claim 1, further comprising:
a first impact damper assembly located proximate the first suspension system.

11. The pallet of claim 10, wherein the first impact damper assembly comprises a rod-type air damper extending from the upper frame down toward the lower frame, and having a bumper at the lower end for impacting the lower frame when the upper frame moves toward the lower frame by a sufficient distance.

12. The pallet of claim 1, further comprising:
a plurality of stacking features.

13. The pallet of claim 12, wherein each stacking feature comprises a tubular member that has a lower end fixed to an opening in the lower frame, and an upper portion that passes up through an opening in the upper frame, such that the upper frame can move up and down along the tubular member.

14. The pallet of claim 13, wherein each stacking feature includes a pin projecting upward from an upper end of the tubular member and that can be fit within an open bottom end of a tubular member of a second pallet the purpose of stacking the second pallet atop the first pallet.

15. A pallet system, comprising:
the pallet of claim 1; and
a ramp removably connected to a side region of the pallet by at least one fastener.

16. A pallet system, comprising:
the pallet of claim 1; and
a ramp connectable to a side region of the pallet, wherein the ramp includes laterally spaced apart rail sections that are interconnected in a manner that permits a spacing between the rail sections to be adjusted.

17. The pallet system of claim 16, wherein the ramp the ramp is a first portion and a second portion that are hinged together so as be movable between a folded/transport configuration and an unfolded/use configuration, wherein the ramp includes a set of rollers for rolling movement of the ramp when in the folded/transport configuration.

18. The pallet system of claim 16, wherein the ramp includes multiple projections at one end thereof and configured for engagement into multiple corresponding openings on a side portion of the pallet.
